(19) United States
(12) Patent Application Publication
(10) Pub. No.: US 2017/0212555 A1
(43) Pub. Date: Jul. 27, 2017

(54) DISPLAY AND CONTROL SYSTEMS FOR WATERCRAFT

(71) Applicant: Chaparral Boats, Inc., Nashville, GA (US)

(72) Inventor: Michael J. Fafard, Nashville, GA (US)

(21) Appl. No.: 15/004,076

(22) Filed: Jan. 22, 2016

(51) Int. Cl. G06F 1/16; F16B 1/00; G07C 5/08; G01C 21/20; G07C 5/02; F16M 13/02; B60K 35/00

(52) U.S. Cl. CPC G06F 1/1632; F16M 13/02; F16B 1/00; G06F 1/1626; B60K 35/00; G01C 21/20; G07C 5/02; G07C 5/08; F16B 2001/0035

(57) ABSTRACT

Watercraft can be adapted with devices and systems for displaying watercraft operational data, and for receiving user input to control the watercraft. Some devices described herein are configured to releasably mount a computing device to the helm of the watercraft in a convenient, user-friendly manner. The helm-mounted computing device can be configured to display a variety of watercraft-related data, and to receive user input. Moreover, the mounting devices described herein allow the computing device to be readily removed from the helm area so the computing device can be transported for use away from the watercraft.

### BACKGROUND

This document relates to devices and systems for boating.

Watercraft typically include one or more helm-mounted gauges that display operational data such as engine RPM, fuel level, battery voltage, oil pressure, and water speed. In some cases, such helm-mounted gauges are prone to becoming inaccurate, difficult to read, and/or are prone to failure.

### SUMMARY

This document provides devices and systems for displaying watercraft operational data, and for receiving user input to control the watercraft. In some implementations, the devices and systems include a computing device (such as a tablet computer) and a watercraft-mounted computing device holder for conveniently mounting the computing device to the watercraft.

Some devices described herein are configured to releasably mount a computing device to the watercraft in a convenient, user-friendly manner that may provide a removable watercraft-mounted computing device. A removable watercraft-mounted computing device can be configured to display a variety of watercraft-related data, and to receive user input. Moreover, the watercraft-mounted computing device holder devices described herein allow the computing device to be readily removed from the watercraft so the computing device can be transported for remote programming, and other uses away from the watercraft.

In one implementation, a holding device for releasably attaching a computing device to a watercraft includes a receiver portion configured to releasably receive a computing device, and a mounting portion that is movably coupled with the receiver portion. The mounting portion is configured for mounting the holding device to the watercraft.

Such a holding device for releasably attaching a computing device to a watercraft may optionally include one or more of the following features. The receiver portion may be pivotably coupled to the mounting portion. The holding device may further comprise a latching mechanism configured and operable to releasably detain the receiver portion in a closed position adjacent to the mounting portion. The latching mechanism may include one or more magnets. The holding device may further comprise a charging indicator attached to the holding device. Such a charging indicator may be configured and operable to activate in response to energy being supplied to the computing device while the computing device is received in the receiver portion. The holding device may further comprise one or more vibration dampening members configured to dampen vibrations from being transmitted to the computing device while the computing device is received in the receiver portion. The receiver portion may be configured to releasably receive a tablet computer that is configured to interface with an electrical communications interface coupled to the watercraft to facilitate electrical communications between the computing device and one or more electrical devices of the watercraft.

In another implementation, a system includes a watercraft and a computing device holder attached to the watercraft. The computing device holder includes a mounting portion attached to the watercraft, and a receiver portion that is movably coupled with the mounting portion. The receiver portion is configured to releasably receive a computing device.

Such a system may optionally include one or more of the following features. The mounting portion may be attached to a helm of the watercraft. The receiver portion may be pivotably coupled to the mounting portion. The system may further comprise a latching mechanism configured and operable to releasably detain the receiver portion in a closed position adjacent to the mounting portion. The latching mechanism may include one or more magnets. The system may further comprise an electrical communications interface coupled to the watercraft and configured to facilitate electrical communications between the computing device and one or more electrical devices of the watercraft.

In another implementation, a system includes a computing device holder configured for releasably coupling a computing device to a watercraft, and computer-coded executable instructions for operating the computing device. The executable instructions adapt the computing device to receive data from one or more sensors of the watercraft and to display information based on the data.

Such a system may optionally include one or more of the following features. The system may further comprise a computing device. The computing device holder may includes a receiver portion configured to releasably receive the computing device, and a mounting portion that is movably coupled with the receiver portion. The mounting portion may be configured for mounting the holding device to the watercraft. The one or more sensors of the watercraft may monitor operations of an engine of the watercraft. The operations of the engine may be selected from the group consisting of RPM, temperature, oil pressure, and voltage. The executable instructions may adapt the computing device to display a map for navigation of the watercraft. The executable instructions may adapt the computing device to display a depth of water or to control an entertainment system of the watercraft.

Particular embodiments of the subject matter described in this document can be implemented to realize one or more of the following advantages. First, in some implementations the watercraft-mounted computing device holders provided herein facilitate convenient installation and removal of a computing device in relation to the watercraft. For example, in some implementations a user can utilize the computing device while it is mounted to the helm of the watercraft, while the computing device is removed from the helm and hand-held (or mounted in another watercraft-mounted computing device holder on the same or a different watercraft), and while the computing device is removed from the watercraft completely.

Second, because the watercraft-mounted computing device holders provided herein facilitate convenient removal of a computing device in relation to a watercraft, a user can advantageously program or configure the computing device while it is remote from the watercraft. In one such example, a user can chart a course on a navigation system of the computing device while the computing device is used in the comfort of the user's home.

Third, the use of the computing device in conjunction with the watercraft-mounted computing device holders allows for the computing device's data to be readily backed-up on another system. For example, the back-up data can be saved on another computer (such as the user's personal computer) or a cloud-based database server.

Fourth, the use of the computing device in conjunction with the watercraft-mounted computing device holders provides a highly versatile and flexible watercraft display and control center. As described further below, multiple watercraft systems can be monitored and controlled in a centralized fashion using the devices and systems provided herein. For example, such watercraft systems can include, but are not limited to, engine parameter monitors, global positioning system (GPS), depth finder, entertainment systems, communication systems, ancillary systems, and the like. Using the devices and systems provided herein to monitor and control such a variety of systems provides convenience for a helmsman because of consolidation.

Fifth, the consolidation of watercraft monitoring and control systems provided by the devices and systems described herein can enhance the overall reliability of such systems. For example, by reducing the numbers of display and control devices through consolidation, the sum potential for failures of such display and control devices may be reduced.

Although methods and materials similar or equivalent to those described herein can be used to practice the invention, suitable methods and materials are described herein. In case of conflict, the present specification, including definitions, will control. In addition, the materials, methods, and examples are illustrative only and not intended to be limiting.

The details of one or more embodiments of the invention are set forth in the accompanying drawings and the description herein. Other features, objects, and advantages of the invention will be apparent from the description and drawings, and from the claims.

### DESCRIPTION OF THE DRAWINGS

FIG. 1 is a perspective view of a watercraft helm and a helm-mounted display and control system in accordance with some embodiments.

FIG. 2 is an exploded perspective view of a portable computing device and a holder configured for mounting the computing device on a watercraft.

FIG. 3 is a perspective view of a mated arrangement of the computing device and holder of FIG. 2 in a first configuration.

FIG. 4 is a perspective view of a mated arrangement of the computing device and holder of FIG. 2 in a second configuration.

Like reference numbers represent corresponding parts throughout.

### DETAILED DESCRIPTION

This document provides devices and systems for displaying watercraft operational data, and for receiving user input for controlling the watercraft. Some devices described herein are configured to releasably mount a computing device to the watercraft in a convenient, user-friendly manner. A watercraft-mounted computing device can be configured to display a variety of watercraft-related data, and to receive user input for controlling the watercraft's systems.

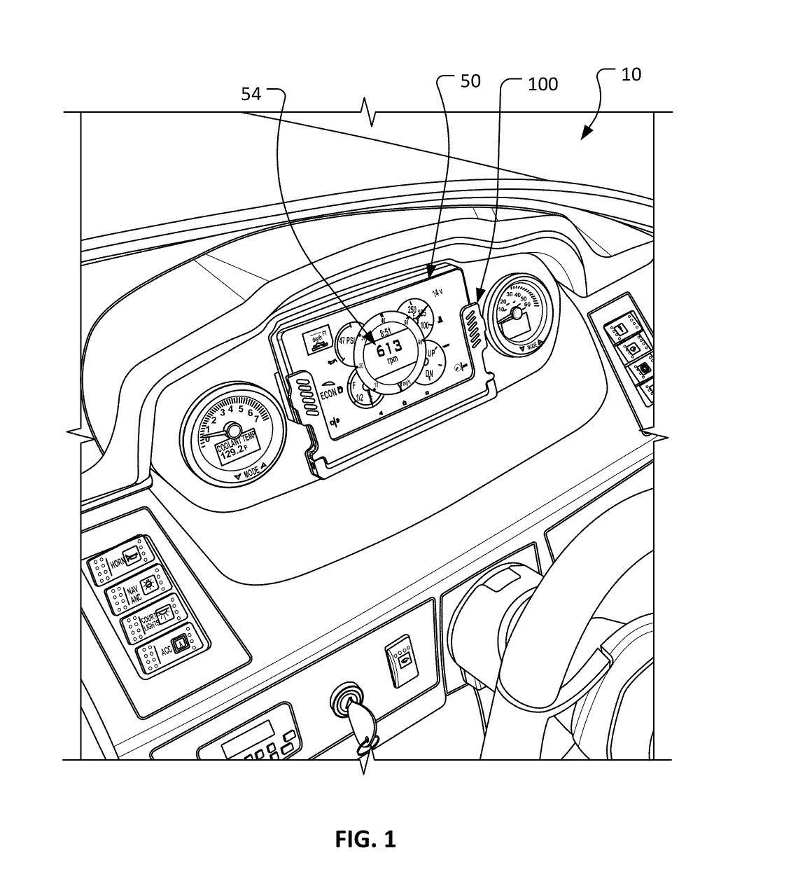

Referring to FIG. 1, a watercraft 10 can be adapted to include a computing device 50 that is removably coupled to the watercraft 10 using a watercraft-mounted computing device holder 100. The computing device 50 can be in communication with multiple systems of the watercraft 10, whereby the computing device 50 can provide a centralized, consolidated monitoring and control apparatus. For example, in some implementations the computing device 50 can be used to monitor and control watercraft systems such as, but not limited to, engine parameters (e.g., RPM, fuel level, temperature, battery voltage, oil pressure), GPS, depth finder, entertainment systems, communication systems, ancillary systems (e.g., bilge pump, engine compartment ventilation fan, lights, etc.), and the like.

In some embodiments, the computing device 50 is configured with executable instructions (e.g., code, one or more applications, one or more computer programs, etc.), saved in the memory of the computing device 50, that allows the computing device 50 to function as desired in relation to the watercraft 10. In one example, the computing device 50 is configured with executable instructions that allow the computing device 50 to interface with engine sensors, to interpret signals from the sensors, and to display data corresponding to the signals from the sensors. For example, in some embodiments the computing device 50 may receive a voltage signal from an engine speed sensor that monitors a RPM of the engine of the watercraft 10. The executable instructions saved in the memory of the computing device 50 may allow the conversion of the voltage signal to a RPM data point, and allow the computing device 50 to present a graphical representation of the RPM data on the user interface of the computing device 50, as depicted by RPM display 54.

As shown, some other example types of data that can be displayed on the computing device 50 can include, but are not limited to, water depth, fuel level, oil pressure, engine temperature, time, trim level of the drive unit, battery voltage, warning indicators, and so on. In addition, the computing device 50 can be configured to perform other functions such as, but not limited to, GPS maps and navigation, operation of entertainment systems (e.g., audio, video, video camera, etc.), communications (e.g., email, text messaging, emergency messaging, etc.), and the like.

In some embodiments, the communications between the computing device 50 and one or more electrical devices of the watercraft are wired communications facilitated by an electrical communications interface (not shown) coupled to the watercraft. For example, the watercraft-mounted computing device holder 100 can include an electrical interface that connects a communication port (or other interface) of the computing device 50 with conductors that connect to sensors, devices, and/or systems of the watercraft 10 (e.g., speed sensor(s), pressure sensor(s), voltage sensor(s), entertainment system, depth sensing system, radar, and the like). Alternatively, the communications between the computing device 50 and one or more electrical devices of the watercraft are wireless communications (e.g., using Bluetooth, WiFi, GPS, NFC, and the like) facilitated by an electrical communications interface (not shown) coupled to the watercraft. In some embodiments, a combination of wired and wireless communications are used by the computing device 50.

In some embodiments, the computing device 50 receives electrical energy from the watercraft 10. In some such embodiments, energy is transmitted to the computing device via a wired connection (that may or may not also transmit data). Alternatively, in some embodiments watercraft 10 is equipped with an inductive charging system and computing device 50 is configured to receive such inductive energy as a source of energy for operating the computing device 50.

While in the depicted embodiment the watercraft 10 is a sport boat, it should be understood that the devices and systems provided herein can be used with many other types of watercraft such as, but not limited to, sailboats, pontoon boats, hovercraft, merchant vessels, and the like. In the depicted embodiment, the watercraft-mounted computing device holder 100 is mounted to the helm of the watercraft 10. In some embodiments, the watercraft-mounted computing device holder 100 can alternatively be mounted to other locations of the watercraft 10 such as, but not limited to, a bulkhead, a hull, a deck, a console, within a cabin, within an enclosure, and the like. In particular embodiments, two or more of the watercraft-mounted computing device holders 100 can be mounted in a single watercraft 10. In some such embodiments, two or more computing devices 50 may be installed concurrently. In some such embodiments, a single computing device 50 may be physically relocated from one watercraft-mounted computing device holder 100 to one or more other watercraft-mounted computing device holders 100 in the same watercraft 10.

In some cases, the watercraft-mounted computing device holder 100 can be installed in a previously existing watercraft. That is, in some cases the owner of a watercraft may obtain a watercraft-mounted computing device holder 100 (and computing device 50) and mount the watercraft-mounted computing device holder 100 to the watercraft. Alternatively, in some cases a manufacturer or dealer of watercrafts may install a watercraft-mounted computing device holder 100 (and computing device 50) in a new watercraft.

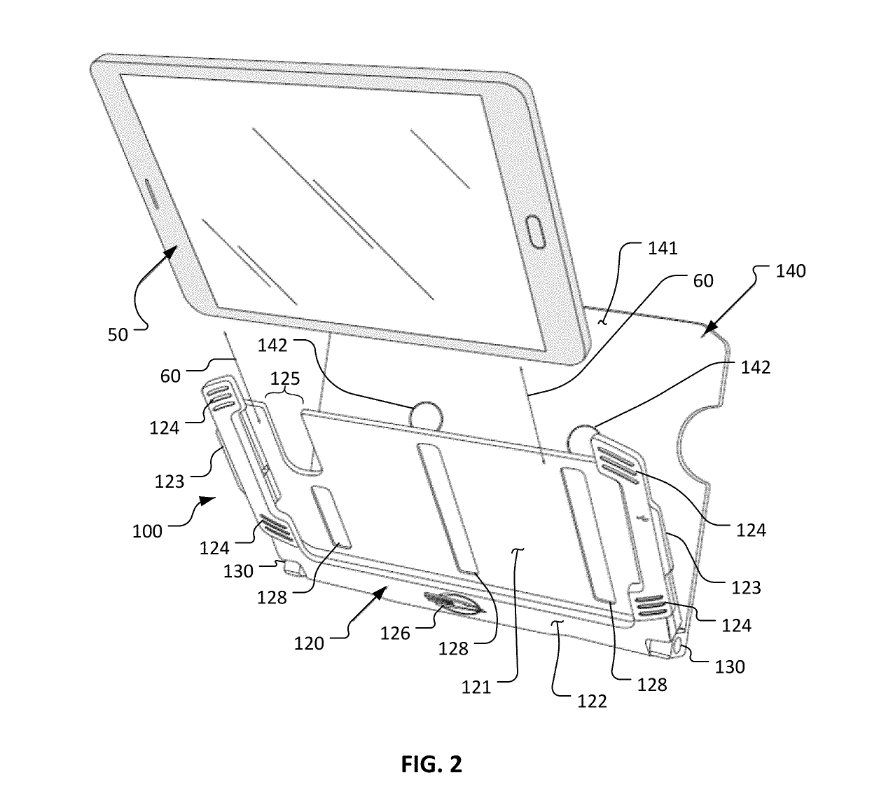

Referring to FIG. 2, in some embodiments the computing device 50 is removably coupleable with the watercraft-mounted computing device holder 100. For example, in the depicted embodiment, the computing device 50 is slidably receivable in the watercraft-mounted computing device holder 100 as depicted by arrows 60. Such an arrangement provides a convenient means for a user to manually install and/or remove the computing device 50 from engagement with the watercraft-mounted computing device holder 100. Other ways of releasably engaging the computing device 50 with the watercraft-mounted computing device holder 100 are also envisioned. For example, in some embodiments the watercraft-mounted computing device holder 100 may include one or more flexible members that are deflectable, and that can thereby retain the computing device 50 in a coupled arrangement with the watercraft-mounted computing device holder 100. Other latching mechanisms, compression mechanisms, magnetic mechanisms, and the like are also envisioned.

While in the depicted embodiment the computing device 50 is a tablet computer, the watercraft-mounted computing device holder 100 can be adapted to interface with other types of computing devices such as, but not limited to, smart phones, laptops, notebook computers, and the like, and different sizes of computing devices (e.g., various sizes of tablet computers). In some embodiments, the watercraft-mounted computing device holder 100 can include spatial adapters (not shown) that allow a single watercraft-mounted computing device holder 100 to compatibly receive various types of computing devices.

In the depicted embodiment, the watercraft-mounted computing device holder 100 includes a receiver portion 120 and a mounting portion 140. The receiver portion 120 is pivotable in relation to the mounting portion 140 about a hinge 130. In the depicted arrangement, the receiver portion 120 is pivoted open to a first orientation in relation to the mounting portion 140. The receiver portion 120 can also be pivoted to a second, closed orientation in relation to the mounting portion 140 (Refer to FIGS. 1 and 4). While the watercraft-mounted computing device holder 100 is in the open orientation, the computing device 50 may be especially conveniently accessible for installing or removing the computing device 50 from the receiver portion 120. In some embodiments, the closed orientation of the watercraft-mounted computing device holder 100 may be the preferred orientation while the computing device 50 is operational.

The receiver portion 120 and the mounting portion 140 can be made from various materials and combinations of materials. For example, some or all of the receiver portion 120 and/or the mounting portion 140 can be made of metals (e.g., aluminum, stainless steel, etc.) and/or various types of plastics (e.g., polystyrene, acrylonitrile butadiene styrene, polyvinyl chloride, polyethylene, high density polyethylene, low density polyethylene, polypropylene, polycarbonate, polyphenelyne ether, polyamide (PA or Nylon), ultra high molecular weight polyethylene, polyimide, polyetherimide, polyphenylene sulfide, or polyetheretherketone, to provide a few examples) and combinations thereof.

In some embodiments, such as the depicted embodiment, the receiver portion 120 includes a receiver panel 121 and a frame 122. The frame 122 is attached to the receiver panel 121 in a manner such that a space is created (between the receiver panel 121 and the frame 122) in which the computing device 50 fits. In the depicted embodiment, the frame 122 is three-sided, leaving the top side open to allow the computing device 50 to be placed into the space between the receiver panel 121 and the frame 122. The computing device 50 is slidably positionable between the receiver panel 121 and the frame 122 as indicated by the arrows 60. The frame 122 retains the computing device 50 within the receiver portion 120 without obstructing the display portion of the computing device 50. In some embodiments, the frame 122 can be four-sided. In some such embodiments, one or more portions of the frame 122 can be removable or hinged, for example, to allow for the computing device 50 to be installed into and removed from the frame 122.

While in the depicted embodiment the computing device 50 is slidably engageable with the watercraft-mounted computing device holder 100, in some embodiments other engagement techniques are used. For example, engagement techniques can be used such as, but not limited to, clamping, press-fitting, encasing, use of magnetics, use of elastic members, and so on.

In some embodiments, the watercraft-mounted computing device holder 100 provides a water-resistant enclosure for the computing device 50. For example, in some embodiments when the computing device 50 is inserted into the watercraft-mounted computing device holder 100, the computing device 50 can be surrounded by sealing material that is compressed when the watercraft-mounted computing device holder 100 is closed, thereby creating a water-tight or water-resistant seal.

The frame 122 can be configured with one or more openings that are useful for the functionality of the computing device. For example, the frame 122 can define one or more speaker ports 124. The speaker ports 124 can be positioned anywhere as needed to coincide with the position(s) of speakers on the computing device 50. Hence, the speaker ports 124 allow sound to pass through the frame 122. Similarly, the frame 122 can also include one or more relief areas coinciding with other elements of the computing device 50 as needed, such as for switches, buttons, cameras, indicator lights, and the like.

In the depicted embodiment, the frame 122 includes a handle 123 on each side of the frame 122. The handle 123 provides a convenient position for a user to grasp the receiver portion 120 and to actuate a pivoting motion to open or close the watercraft-mounted computing device holder 100. In some embodiments, a single handle 123 is included. In some embodiments, no handles are included.

In the depicted embodiment, the frame 122 also includes a charging indicator 126. The charging indicator 126 can be, for example, a light (e.g., one or more LEDs) that is activated when the computing device 50 is receiving energy, and deactivated with the computing device 50 is not receiving energy. In some embodiments, the charging indicator 126 can be in the form of a symbol or logo of a boat manufacturer. The charging indicator 126 can be continuously activated while the computing device 50 is receiving energy, or can be blinking.

In some embodiments, such as the depicted embodiment, the receiver panel 121 includes features such as, but not limited to, a camera relief area 125, resilient members 128, and one or more magnets (not visible; attached to the rear surface of the receiver panel 121 in the depicted embodiment). The camera relief area 125 provides a space that can receive a slightly-projecting camera on the rear of the computing device 50. One or more additional relief areas can be included at other locations on the receiver panel 121 as needed for a particular type of computing device 50.

The receiver panel 121 can also include one or more resilient members 128. In the depicted embodiment, three resilient members 128 are included. In some embodiments, one, two, three, four, five, or more than five such resilient members 128 can be included in the receiver panel 121. The resilient members 128 provide functional advantages such as increasing the friction between the computing device 50 and the receiver portion 120, and providing a compression fit therebetween. Hence, the position of the computing device 50 in relation to the receiver portion 120 may be held substantially constant, even while subjected to impacts, vibrations, and inertial forces as are common with the operations of a watercraft. The resilient members 128 also provide shock absorption and vibration dampening of forces such that the computing device 50 is protected to some extent.

In some embodiments, the receiver panel 121 also includes magnets on the rear of the receiver panel 121. In particular embodiments, the receiver panel 121 itself, or portions thereof, is a magnetize-able material. The magnets can align with corresponding magnets 142 on the mounting portion 140. Such magnets can serve to releasably latch and detain the watercraft-mounted computing device holder 100 in the closed position (e.g., as shown in FIGS. 1 and 4). In some embodiments, other types of latches can be additionally or alternatively included, such as, but not limited to, springs, clamps, closures, ball detents, and the like, and combinations thereof.

The mounting portion 140 includes a mounting panel 141. The mounting panel 141 can be attached at a desired location to the watercraft (e.g., to a helm of a watercraft as shown in FIG. 1). For example, the mounting portion 140 can be attached using screws, pins, rivets, clamps, and the like. In some embodiments, the mounting portion 140 is an integral part of the watercraft (e.g., formed or integrated as part of the helm or other portion of the watercraft).

In some embodiments, such as the depicted embodiment, the mounting portion 140 includes one or more magnets 142 on or in the mounting panel 141. The magnets 142 can be used to releasably latch and detain the receiver panel 121 adjacent to the mounting panel 141, such that the watercraft-mounted computing device holder 100 is configured in the closed arrangement.

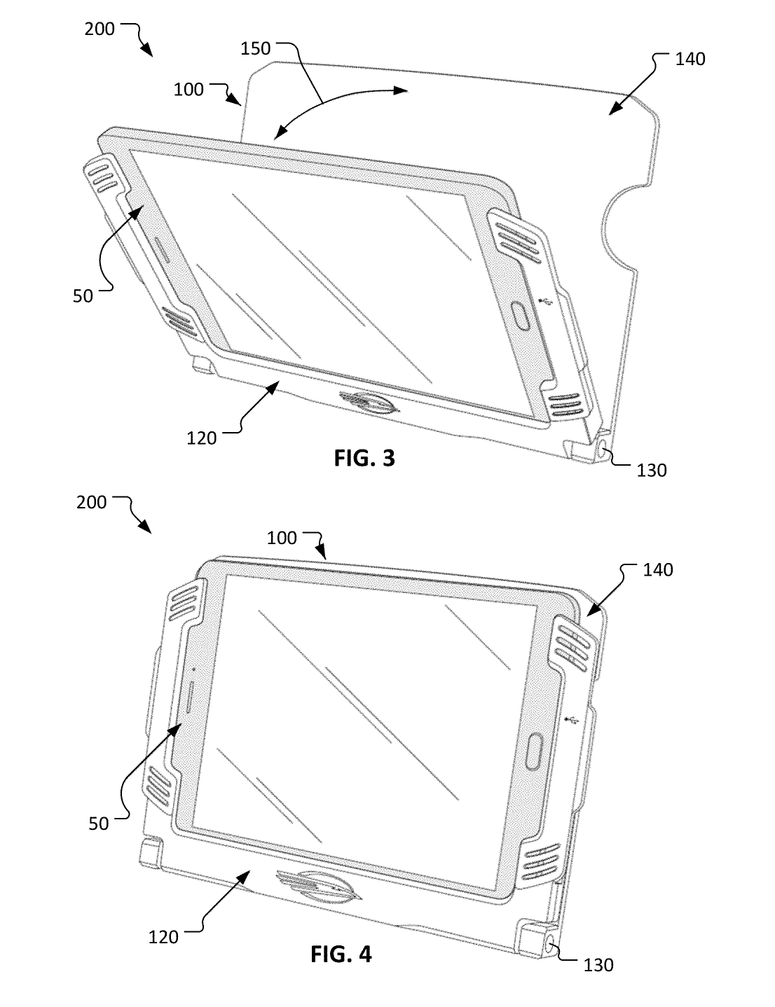

Referring to FIGS. 3 and 4, a watercraft controller system 200 includes a computing device 50 and a watercraft-mounted computing device holder 100. The watercraft controller system 200 can be configured in an open position (FIG. 3) and in a closed position (FIG. 4).

In the depicted embodiment, as described above, the watercraft-mounted computing device holder 100 includes a receiver portion 120 and a mounting portion 140. The receiver portion 120 and the mounting portion 140 are pivotable in relation to each other. In the open position, the receiver portion 120 is well-positioned to become releasably mated with the computing device 50, such as by sliding the computing device into engagement with the receiver portion 120.

From the open position, the receiver portion 120 can be pivoted about a hinge 130, as represented by arrow 150, to the closed position. Pivoting the receiver portion 120 positions the receiver portion 120 adjacent to the mounting portion 140. A latching and detent mechanism can be used to releasably detain the watercraft-mounted computing device holder 100 in the closed position. In the closed position, the watercraft controller system 200 is well-positioned for use in conjunction with the watercraft to which the watercraft controller system 200 is attached. When desired, the watercraft-mounted computing device holder 100 can be pivoted to the open position, and the computing device 50 can be removed.

While this specification contains many specific implementation details, these should not be construed as limitations on the scope of any invention or of what may be claimed, but rather as descriptions of features, that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described herein as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described herein should not be understood as requiring such separation in all embodiments, and it should be understood that the described program components and systems can generally be integrated together in a single product or packaged into multiple products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A holding device for releasably attaching a computing device to a watercraft, the holding device comprising:
a receiver portion configured to releasably receive a computing device, the receiver portion comprising a frame attached to a panel such that a space is defined between the frame and the panel to slidably receive the computing device; and
a mounting portion that is movably coupled with the receiver portion, the mounting portion configured for mounting the holding device to the watercraft,
the holding device being pivotably reconfigurable between: (i) a closed position in which the panel is adjacent to the mounting portion and (ii) an open position in which a portion of the panel is spaced away from the mounting portion relative to the closed position.

2. The holding device of claim 1, wherein the frame includes three or more sides arranged around a perimeter of the panel.

3. The holding device of claim 1, further comprising a latching mechanism configured and operable to releasably detain the panel in the closed position adjacent to the mounting portion.

4. The holding device of claim 3, wherein the latching mechanism comprises one or more magnets.

5. The holding device of claim 1, further comprising a charging indicator attached to the holding device, wherein the charging indicator is configured and operable to activate in response to energy being supplied to the computing device while the computing device is received in the receiver portion.

6. The holding device of claim 1, further comprising one or more vibration dampening members configured to dampen vibrations from being transmitted to the computing device while the computing device is received in the receiver portion.

7. The holding device of claim 1, wherein the receiver portion is configured to releasably receive a tablet computer that is configured to interface with an electrical communications interface coupled to the watercraft and configured to facilitate electrical communications between the computing device and one or more electrical devices of the watercraft.

8. A system comprising:
a watercraft; and
a computing device holder attached to the watercraft, the computing device holder comprising:
a mounting portion attached to the watercraft; and
a receiver portion that is movably coupled with the mounting portion, the receiver portion configured to releasably receive a computing device, the receiver portion comprising a frame attached to a panel such that a space is defined between the frame and the panel to slidably receive the computing device,
the computing device holder being pivotably reconfigurable between: (i) a closed position in which the panel is adjacent to the mounting portion and (ii) an open position in which a portion of the panel is spaced away from the mounting portion relative to the closed position.

9. The system of claim 8, wherein the mounting portion is attached to a helm of the watercraft.

10. The system of claim 8, wherein the frame includes three or more sides arranged around a perimeter of the panel.

11. The system of claim 8, further comprising a latching mechanism configured and operable to releasably detain the panel in the closed position adjacent to the mounting portion.

12. The system of claim 11, wherein the latching mechanism comprises one or more magnets.

13. The system of claim 8, further comprising an electrical communications interface coupled to the watercraft and configured to facilitate electrical communications between the computing device and one or more electrical devices of the watercraft.

14. A system comprising:
a computing device holder configured for releasably coupling a computing device to a watercraft, the computing device holder comprising:
a receiver portion configured to slidably receive the computing device; and
a mounting portion configured for mounting the holding device to the watercraft,
the computing device holder being pivotably reconfigurable between: (i) a closed position in which the receiver portion is adjacent to the mounting portion and (ii) an open position in which a portion of the receiver portion is spaced away from the mounting portion relative to the closed position; and
computer-coded executable instructions for operating the computing device, the executable instructions adapting the computing device to receive data from one or more sensors of the watercraft and to display information based on the data.

15. The system of claim 14, further comprising the computing device.

16. The system of claim 14, wherein the receiver portion comprises a frame including three or more sides attached around a perimeter of a panel such that a space is defined between the frame and the panel to slidably receive the computing device, and wherein the mounting portion is pivotably coupled with the receiver portion.

17. The system of claim 14, wherein the one or more sensors of the watercraft monitor operations of an engine of the watercraft.

18. The system of claim 17, wherein the operations of the engine are selected from the group consisting of RPM, temperature, oil pressure, and voltage.

19. The system of claim 18, wherein the executable instructions adapt the computing device to display a map for navigation of the watercraft.

20. The system of claim 18, wherein the executable instructions adapt the computing device to display a depth of water or to control an entertainment system of the watercraft.
